(19) United States
(12) Patent Application Publication
(10) Pub. No.: US 2014/0264003 A1
(43) Pub. Date: Sep. 18, 2014

(54) Method for Cleaning an Atmospheric Pressure Chemical Ionization Source

(71) Applicant: Thermo Finnigan LLC, San Jose, CA (US)

(72) Inventor: Joseph M. Di Bussolo, West Chester, PA (US)

(73) Assignee: Thermo Finnigan LLC, San Jose, CA (US)

(21) Appl. No.: 14/207,136

(22) Filed: Mar. 12, 2014

Related U.S. Application Data
(60) Provisional application No. 61/783,600, filed on Mar. 14, 2013.

(51) Int. Cl. G01N 30/72; H01J 49/00

(52) U.S. Cl. CPC G01N 30/7233; H01J 49/0027
USPC 250/282; 250/288

(57) ABSTRACT

Build-up of surface contamination within an atmospheric pressure chemical ionization (APCI) source of a mass spectrometer (MS) is reversed by switching the APCI polarity to the opposite setting used for analyte ionization after the analytes have been ionized and measured. A solvent or mixture of solvents is passed through the ion source during the opposite-polarity operation. This cleaning procedure may be repeated after each sample analysis, especially by incorporating the cleaning procedure into an assay method. The cleaning procedure may be employed simultaneously with chromatography column washing steps and enables a mass spectrometer to maintain useful analysis sensitivity without a need for manual ion source cleaning.

### CROSS REFERENCE TO RELATED APPLICATION

This application claims the benefit of the filing date, under 35 U.S.C. 119(e), of co-pending Provisional Application No. 61/783,600, filed on Mar. 14, 2013 and titled “Method for Cleaning an Atmospheric Pressure Chemical Ionization Source” and assigned to the assignee of the instant application, said provisional application for patent incorporated herein by reference in its entirety.

### FIELD OF THE INVENTION

This invention relates to liquid chromatography/mass spectrometry (LCMS) assays and, more particularly, to removing contamination from an atmospheric pressure ionization source used in a mass spectrometer during assays of analytes provided by a liquid chromatograph.

### BACKGROUND OF THE INVENTION

Atmospheric pressure ionization sources for mass spectrometry include both electrospray ionization (ESI) and atmospheric pressure chemical ionization (APCI). Although similar physical configurations are employed in the two ionization techniques, both have their own particular advantages. For instance, although ESI is a softer ionization technique—producing fewer fragment ions than does APCI—and is the method of choice for nonvolatile or thermally labile compounds. However, the APCI technique is better suited for ionizing neutral and weakly-polar compounds and is less sensitive to chemical interferences than is ESI.

In atmospheric pressure chemical ionization (APCI) a charged species is attached or removed from an analyte molecule at atmospheric pressure. Reagent ions are typically produced from a cascade of gas phase reactions initiated in a corona discharge or a glow discharge region at atmospheric pressure. If the gas phase reactions are energetically favorable, the reagent ion will transfer a charged species to an analyte molecule or remove a charged species from an analyte molecule forming an analyte ion. FIG. 1 illustrates an example of a conventional APCI source, generally designated at 10, utilized in, for example, an LCMS system. In general terms, APCI source 10 comprises a sample introduction and nebulizing section, generally designated at 20; a vaporization section, generally designated at 30; an ionization section, generally designated at 40; and an ion inlet section, generally designated at 50. The ion inlet section 50 includes a front plate 52 having an ion inlet aperture 53 through which ionized products are directed into the mass analyzer of the mass spectrometer (not specifically shown, but which would appear, if shown, on the left side of the diagram of FIG. 1).

Nebulizing section 20 comprises a capillary tube 23, typically a metal capillary, that serves as the sample inlet system of the mass spectrometer. Capillary tube 23 conducts the LC column flow from a liquid chromatographic apparatus into vaporization section 30. In addition, a length of conduit 27 for directing a suitable inert nebulizing gas such as nitrogen into vaporization section 30 is coaxially disposed about the capillary tube 23. The vaporization section 30 of the APCI ion source 10 generally includes a vaporizing tube 33 and a heater 35 enclosed in a coaxial housing (not shown), and a conduit 37 for directing a suitable inert vaporizing (“auxiliary” or “make-up”) gas such as nitrogen into the vaporizing tube 33. Heater 35 is situated so as to ensure sufficient thermal contact with the wall of the vaporizing tube 33. The wall of vaporizing tube 33 is typically quartz, and can operate at temperatures ranging from about 200-600° C. to rapidly vaporize effluent from capillary tube 23. While the thermal effect on typical samples is minimal, such a technique is not compatible with very thermally labile molecules. Capillary tube 23 is disposed along the central axis of the vaporizing tube 33 and terminates at a capillary tube outlet 23A within the vaporizing tube 33. A portion of the vaporizing gas conduit 37 is coaxially disposed about the nebulizing gas conduit 27 as well as the capillary tube 23.

Ionization section 40 of APCI source 10 generally includes an ionization chamber 42 defining an enclosed volume into which a corona needle or pin 43 is inserted. The corona needle 43 typically operates at about 5-10 kV and 1-5 mA to strike a low-current corona discharge or electron cloud 45 within ionization section 40. This electrical discharge 45 enables the generation of the afore-mentioned chemical reagent gas plasma utilized to ionize the sample molecules. Vaporizing tube 33 terminates at a vaporizing tube outlet 33A in fluid communication with ionization chamber 42, whereby vaporized analyte and mobile-phase constituents are transferred into chamber 42 for ionization. One or more voltage sources (not shown) are typically provided to impress a voltage between front plate 52 of ion inlet section 50 and one or more electrically conductive surfaces in ionization section 40 such as corona needle 43, thereby establishing one or more electric fields sufficient to attract ionized products derived from the vaporized LC eluent into ion inlet section 50 through ion inlet aperture 53. Either a positive polarity voltage or a negative polarity voltage may be applied to the corona needle 43.

In operation, a liquid sample comprising the LC column flow from a liquid chromatographic apparatus is introduced into the heated vaporizing tube 33 via capillary tube 23, typically at a flow rate of about 0.1-2.0 ml/min. Nebulizing and vaporizing gas streams are introduced into the vaporizing tube 33 through the nebulizing gas conduit 27 and the vaporizing gas conduit 37, respectively. The nebulizing gas flows concentrically around centrally disposed capillary tube 23 at a high velocity and a typical pressure of about 0.8 MPa, thereby nebulizing the liquid sample into small liquid droplets as the nebulizing gas and liquid sample enter vaporizing tube 33. Because the wall of vaporizing tube 33 is heated by heater 35 and consequently transfers heat energy into the interior of vaporizing tube 33, the liquid droplets of the nebulized sample entering the vaporizing tube 33 are converted into vapor. The vaporizing gas is added to the system at a typical flow rate of about 1-3 L/min by means of the vaporizing gas conduit 37. The flow of vaporizing gas assists in sweeping or transporting the liquid-droplet and vapor phases of the sample containing aerosol through vaporizing tube 33. The resulting vapor temperature of the aerosol is about 100° C. The heated gas/vapor then passes in a sample exhaust stream 60 into chamber 42 and into the low-current corona discharge 45 established by corona needle 43 in ionization section 40, where the charge-neutral sample is ionized by ion-molecule reactions with the reagent ions formed in corona discharge 45.

As is well known in the mass spectrometry art, various components of mass spectrometers must be kept clean and free from contamination, which can cause degradation of instrument performance. The interior surfaces of atmospheric pressure ionization sources are especially prone to such contamination, since they are routinely exposed, during operation, to sample aerosols which may frequently include non-volatile compounds. With regard to APCI ion sources, it has been found that accumulation of sample matrix components on the interior surfaces of the source can cause loss of sensitivity for some LCMS bio-analytical assays. The contaminants are found to be particularly localized on the corona discharge needle, which is responsible for ionizing molecules to be analyzed (analytes). For example, the anlayte cortisol, which is measured in urine samples using LCMS with APCI, is ionized by a positive voltage so that it can be electromagnetically drawn into the MS for analysis and measurement. However, contaminants from the urine sample enter the APCI source and coat its surfaces, thereby reducing its ionization efficiency, which results in loss of sensitivity. This sensitivity loss is significant even after the first few sample injections of urine samples and becomes progressively worse after each such injection.

Conventional methods for removing contamination from APCI sources generally involve removal or disassembly of the contaminated ion source followed by manual cleaning. Subsequently, after putting the ion source back into service, the mass spectrometer may need to be recalibrated. Such manual cleaning is therefore wasteful of time and resources and, furthermore, is not practical given the rapidity with which contamination can build up on an APCI corona discharge needle.

### SUMMARY

The inventor has discovered that the surface contamination within an APCI source can be reversed by switching the voltage of the APCI source to the opposite setting used for analyte ionization after the analytes have been ionized and measured. Thus, adding a scan event having a voltage polarity opposite to that of an existing mass spectrometer (MS) data acquisition method prevents accumulation of sample contaminants on the surfaces of the MS ion source. A mixture of solvents may be passed through the chromatograph and ion source during the additional opposite-polarity scan event.

According to one aspect of the present teachings, there is provided a method for performing repeated liquid chromatography/mass spectrometry (LCMS) assays of a plurality of samples using a mass spectrometer comprising an atmospheric pressure chemical ionization (APCI) ion source, the method comprising: (a) performing one or more of the sample assays using the APCI ion source operated in a first operation configuration in which ionization performed by the APCI ion source is conducted using a first voltage polarity; (b) setting operation of the APCI ion source to a second configuration such that subsequent ionization performed by the APCI ion source is conducted using a different voltage polarity opposite to the first voltage polarity; (c) causing a flow of sample-free solvent liquid to flow through the APCI ion source while the ion source is operated using the second operation configuration; and (d) performing one or more additional sample assays using the APCI ion source operated in the first operation configuration.

According to a second aspect of the present teachings, a liquid chromatography mass spectrometry (LCMS) system for performing sample assays is provided, wherein the system comprises: (i) a mass spectrometer comprising an atmospheric pressure chemical ionization (APCI) ion source; (ii) a chromatograph fluidically coupled to the APCI ion source; and (iii) an electronic controller electronically coupled to the chromatograph and the APCI ion source, the electronic controller comprising program instructions operable to: (a) cause the LCMS system to perform one or more sample assays using the APCI ion source operated in a first operation configuration in which ionization performed by the APCI ion source is conducted using a first voltage polarity; (b) set operation of the APCI ion source to a second configuration such that subsequent ionization performed by the APCI ion source is conducted using a different voltage polarity opposite to the first voltage polarity; (c) cause a flow of sample-free solvent liquid to flow through the APCI ion source while the ion source is operated using the second operation configuration; and (d) cause the LCMS system to perform one or more additional sample assays using the APCI ion source operated in the first operation configuration.

### BRIEF DESCRIPTION OF THE DRAWINGS

The above noted and various other aspects of the present invention will become apparent from the following description which is given by way of example only and with reference to the accompanying drawings, not drawn to scale, in which:

FIG. 1. is a generalized illustration of a conventional atmospheric pressure chemical ionization (APCI) ion source.

FIG. 2 is a plot of the variation of the peak area attributable to cortisol in a series of mass chromatograms of cortisol in urine.

FIG. 3 is a plot of the variation of the peak area attributable to cortisol in a second series of mass chromatograms of cortisol in urine wherein the mass chromatograms were alternated with cleaning procedures in accordance with the present teachings.

FIG. 4 is a flow chart of a method in accordance with the present teachings.

FIG. 5 is a schematic diagram of an liquid chromatography/mass spectrometry (LCMS) system on which the invention, according to various of its aspects, may be practiced.

### DETAILED DESCRIPTION

This disclosure describes improved mass spectrometry methodology for use with liquid chromatography. The following description is presented to enable any person skilled in the art to make and use the invention, and is provided in the context of a particular application and its requirements. Various modifications to the described embodiments will be readily apparent to those skilled in the art and the generic principles herein may be applied to other embodiments. Thus, the present invention is not intended to be limited to the embodiments and examples shown but is to be accorded the widest possible scope in accordance with the features and principles shown and described. To more particularly appreciate the features of the present invention, the reader is referred to FIGS. 2 through 4 in conjunction with the following description.

### Example 1

In order to verify the effectiveness of the APCI cleaning procedure described herein, a series of repeated LCMS analyses were performed on samples comprising 75 μL injections of cortisol-containing urine samples diluted with aqueous 5 mM ammonium acetate (AmAc) in a ratio of 1 part urine to 2.5 parts diluent. Each injected sample contained 150 ng/mL cortisol. The chromatography system included a first cleanup column comprising a High-Turbulence-Liquid Chromatography TurboFlow™ “cleanup” column for removing a variety of non-analyte compounds and a reversed-phase Hypersil™ Gold C18 column for specifically separating cortisol from other compounds. Both such columns are available from Thermo Fisher Scientific of Waltham, Mass. USA.

The two mobile phases used for chromatography comprised pure water and pure methanol, respectively, without pH control or preservatives. Pure water was used to focus the analyte onto the analytical column; elution was performed using pure methanol. The mass spectrometer, which included an APCI ion source operated in positive ion mode for purposes of the analyses, generated a cortisol ion chromatogram for each sample based on four different detected fragment ions. The entire procedure of loading sample onto the columns, eluting the analyte to the detector and re-equilibrating the columns consumed three-and-one-half minutes for each sample.

The area under the curve of the cortisol ion chromatogram peak was measured for each of three-hundred injections performed as described above. The APCI was cleaned prior to the first injection but no other cleaning was performed during this set of analyses. FIG. 2 shows a plot of the variation of the cortisol ion chromatogram peak area over the course of the three hundred analyses. The instrument sensitivity, as indicated by the peak area curves, exhibit an immediate decline which becomes progressively worse. For example, the sensitivity decreases by nearly 50 percent after the first ten injections. After the twentieth injection, the cortisol peak area has declined to approximately 35 percent of its initial value; after the one-hundredth injection, the peak area is only seven percent of its initial value. Overall, the peak area decreased by over ninety-seven percent.

After performing the series of injections whose results are shown in FIG. 2, the APCI was “electrocleaned” by switching its operation to negative polarity mode while a mixture of solvents was pumped through the source. The mixture of solvents used for this step was prepared by mixing two parts by volume of acetonitrile with two parts by volume of 2-propanol and one part by volume of acetone. This cleaning step was performed for a total of thirty minutes. After the cleaning step, the APCI was switched back to positive polarity mode and the cortisol in urine was detected as before. It was found that the peak area of the first cortisol analysis following the thirty-minute cleaning was roughly twenty-five times greater than the peak measured on the three-hundredth injection just prior to performing the cleaning procedure. Thus, the above-described electrocleaning causes the instrument to regain sufficient sensitivity to run additional samples. However, full sensitivity was not recovered, possibly because of contamination of downstream mass spectrometer components.

### Example 2

Although the above-described set of experiments demonstrates the capability of the electrocleaning procedure (operating the APCI in negative polarity while flowing a mixture of solvents through the ion source) to improve instrument sensitivity, it does not address the loss of sensitivity after each injection, especially during the initial injections after installing a fresh or new APCI corona discharge needle electrode or APCI ion source system. Further, the cleaning procedure described above renders the analytical instrument inoperative while the cleaning is being performed.

To address these issues noted in the above paragraph, a second set of experiments was performed in which the electrocleaning procedure was incorporated into the assay method. In this second set of experiments, the APCI source operation was switched from positive to negative immediately after the cortisol measurement of each and every sample such that most contaminants are released from the APCI surfaces as soon as they form. Thus, accumulation of surface contaminants is prevented and MS sensitivity is maintained as additional urine samples are analyzed. Further, by incorporating the APCI electrocleaning procedure into the analytical method, this cleaning may be performed simultaneously with normal column washing steps, so that more time is available for sample analysis.

FIG. 3 is a plot of the variation of the cortisol peak area measured in a second series of injections of urine-borne cortisol, wherein the cortisol analyses were alternated with the cleaning procedure. Comparison of FIG. 3 with FIG. 2 clearly shows less drastic decrease in sensitivity over time in this second set of experiments. Using the electrocleaning procedure after every analysis enabled the instrument to retain seventy percent of its initial sensitivity after ninety-five injections. Moreover, after an initial decrease in sensitivity over approximately first forty injections, the subsequent rate of change in sensitivity becomes less pronounced over the remaining injections.

### CONCLUSION

In accordance with the above discussion, a general method in accordance with the present teachings is provided in flow-chart form in FIG. 4. In the method 200 shown in FIG. 4, the first step, step 202, comprises injecting an analyte-bearing sample that includes biological material—such as urine—into a chromatography system. Urine is used as an example in the above discussion since it is a common matrix in which drug samples are analyzed. However, the method can be employed with any sample that induces contamination within an APCI source. The next step, step 204, comprises separating and eluting sample analytes into a mass spectrometer APCI source in conventional fashion.

Subsequently, in step 206 of the method 200, the analytes are analyzed by the mass spectrometer while operating the APCI at an appropriate voltage. Different assays may employ their own respective voltages, elution times, mobile phases, etc. However, the method according to the present teachings is considered to cover all such variations. In step 208, the operating voltage of the APCI source of the mass spectrometer is switched such that the voltage polarity is opposite of that used to ionize the analytes. For instance, if the APCI is operated using a positive polarity in step 206, it is switched to negative polarity in step 208. Also, during step 208, the APCI source is operated using the reversed polarity while a sample-free solvent is passed introduced into the source. The solvent may be a solvent similar to that used to wash the columns. For instance, a suitable solvent comprises a mixture of two parts by volume of acetonitrile with two parts by volume of 2-propanol and one part by volume of acetone. For efficiency, column washing steps may occur simultaneously with the execution of step 208.

Finally, in step 209 of the method 200, the APCI voltage polarity is switched so as to be appropriate for the next sample analysis. If a series of samples are being analyzed according to a common assay, then this step will comprise a second reversal of the operating voltage polarity back to its initial state. The set of steps 202-209 may be repeated for each sample so as to prevent progressive build-up of contamination of the APCI source. This “electro-cleaning” method alleviates the need to manually clean the MS source, resulting in significant time and cost savings.

The set of steps 202-209 may be possibly performed as part of an assay “test method” or, simply “method” in commonly-used shortened form. Most such LCMS assay methods are presently performed in automated fashion, under the control of software or firmware of a computer or other electronic controller. Accordingly, FIG. 5 is a schematic diagram which summarizes the general components of a system 300 which can perform such automated assays including ion source cleaning steps in accordance with the present teachings. A liquid chromatograph 333 receives a sample 332 of an analyte mixture and at least partially separates the analyte mixture into individual chemical constituents. The at least partially separated chemical constituents are transferred to a mass spectrometer 334 at different respective times for mass analysis. As each chemical constituent is received by the mass spectrometer, it is ionized by an APCI ionization source 301 of the mass spectrometer. The ionization source 301 may produce a plurality of ions (i.e., a plurality of precursor ions) comprising differing charges or masses from each chemical component that elutes from the chromatograph at its own characteristic time. These various ion types are analyzed and detected by the mass spectrometer together with its detector 335 and, as a result, appropriately identified according to their various mass-to-charge ratios. The mass spectrometer may comprise a reaction cell or collision cell 339 to fragment or cause other reactions of the precursor ions and produce product ions for further analysis.

Still referring to FIG. 5, a programmable processor 337 is electronically coupled to the detector of the mass spectrometer and receives the data produced by the detector during chromatographic/mass spectrometric analysis of the sample(s). The programmable processor may comprise a separate stand-alone computer or may simply comprise a circuit board or any other programmable logic device operated by either firmware or software. The programmable processor may also be electronically couple to the APCI ion source 301 as well as to various other electrodes within the mass spectrometer so as to control, for example, various electrode voltages and voltage polarities and the timing of the application of such voltages. The programmable processor may also be electronically coupled to the chromatograph and/or the mass spectrometer in order to transmit electronic control signals to one or the other of these instruments so as to control their operation. The programmable processor may also be electronically coupled to a display or other output 338, for direct output of data or data analysis results to a user, or to electronic data storage 336.

The programmable processor 337 may be electronically coupled to various valves and various fluidic pumps of the liquid chromatograph 333 so as to control the flow of sample-bearing fluids through the chromatograph columns at any time during execution of an automated chromatography method. In general, a liquid chromatographic “test method” (or simply “method”) comprises a sequence of timed steps during which the mixing of sample and solvents, the compositions of mobile phases and the flow directions and flow rates of sample and mobile phases through one or more chromatographic columns are controlled. Such test methods are frequently specific to certain assays. With regard to the present teachings, a method may be implemented as a sequence of programmed steps that includes steps to periodically reverse the voltage polarity applied to a corona discharge needle electrode of the APCI source 301 and to cause a flow of sample-free solvents to flow through the APCI source during such times. Such steps may include steps similar to those illustrated as part of the method 200 shown in FIG. 4, thereby providing an automated, programmed implementation of the APCI cleaning procedures discussed herein.

The discussion included in this application is intended to serve as a basic description. Although the present invention has been described in accordance with the various embodiments shown and described, one of ordinary skill in the art will readily recognize that there could be variations to the embodiments and those variations would be within the scope of the present invention. The reader should be aware that the specific discussion may not explicitly describe all embodiments possible; many alternatives are implicit. Accordingly, many modifications may be made by one of ordinary skill in the art without departing from the scope of the invention. Neither the description nor the terminology is intended to limit the scope of the invention—the invention is defined only by the claims. Any patents, patent publications or other publications mentioned herein are hereby incorporated by reference in their respective entireties.

What is claimed is:

1. A method for performing repeated liquid chromatography/mass spectrometry (LCMS) assays of a plurality of samples using a mass spectrometer comprising an atmospheric pressure chemical ionization (APCI) ion source comprising:
(a) performing one or more of the sample assays using the APCI ion source operated in a first operation configuration in which ionization caused by the APCI ion source is performed using a first voltage polarity;
(b) setting operation of the APCI ion source to a second configuration such that ionization caused by the APCI ion source operated in the second configuration is performed using a different voltage polarity opposite to the first voltage polarity;
(c) causing a flow of sample-free solvent liquid to flow through the APCI ion source while the ion source is operated using the second operation configuration; and
(d) performing one or more additional sample assays using the APCI ion source operated in the first operation configuration.

2. A method as recited in claim 1, wherein the step (c) is performed for a period of time such that at least a portion of an initial sensitivity of the mass spectrometer is restored after the performing of step (c).

3. A method as recited in claim 1, wherein the step (c) is performed simultaneously with an additional step of:
(c1) causing a flow of a cleaning solvent liquid to flow through a column of a chromatograph of the LCMS system.

4. A method as recited in claim 1, wherein the step (a) consists of performing exactly one sample assay using the APCI ion source operated in the first operation configuration and wherein the step (d) consists of performing exactly one additional sample assay using the APCI ion source operated in the first operation configuration.

5. A method as recited in claim 1, wherein the steps (a) through (d) are performed automatically under the control of programmed software or firmware.

6. A method as recited in claim 1, wherein the first voltage polarity is positive and the second voltage polarity is negative.

7. A method as recited in claim 1, wherein the step (c) comprises causing a flow of a solvent liquid comprising a mixture of two parts by volume of acetonitrile, two parts by volume of 2-propanol and one part by volume of acetone to flow through the APCI ion source while the ion source is operated using the second operation configuration.

8. A liquid chromatography/mass spectrometry (LCMS) system for performing sample assays comprising:
(i) a mass spectrometer comprising an atmospheric pressure chemical ionization (APCI) ion source;
(ii) a chromatograph fluidically coupled to the APCI ion source; and
(iii) an electronic controller electronically coupled to the chromatograph and the APCI ion source, the electronic controller comprising program instructions operable to:
(a) cause the LCMS system to perform one or more sample assays using the APCI ion source operated in a first operation configuration in which ionization caused by the APCI ion source is performed using a first voltage polarity;
(b) set operation of the APCI ion source to a second configuration such that ionization caused by the APCI ion source operated in the second configuration is performed using a different voltage polarity opposite to the first voltage polarity;
(c) cause a flow of sample-free solvent liquid to flow through the APCI ion source while the ion source is operated using the second operation configuration; and
(d) cause the LCMS system to perform one or more additional sample assays using the APCI ion source operated in the first operation configuration.
